(19) United States
(12) Patent Application Publication
(10) Pub. No.: US 2018/0002958 A1
(43) Pub. Date: Jan. 4, 2018

(54) Pivot Hinge Assembly For Glass Door

(71) Applicant: Bath Authority LLC dba Dreamline, Warminster, PA (US)

(72) Inventors: Vadym Mironchuk, Southampton, PA (US); Brian Lieb, Philadelphia, PA (US); Michael Minkovich, Richboro, PA (US)

(21) Appl. No.: 15/199,558

(22) Filed: Jun. 30, 2016

(51) Int. Cl. E05D 5/02; E05D 7/081; A47K 3/36

(52) U.S. Cl. CPC E05D 5/0246; A47K 3/36; E05D 7/081

(57) ABSTRACT

A pivot hinge assembly for supporting a glass door of a shower enclosure is disclosed. The pivot hinge assembly includes an exterior plate having a body configured for mounting on a glass panel, the exterior plate defining at least two fastening receiving holes, a pivot mounting member having a body configured for mounting on an opposite side of the glass panel, the pivot mounting member defining at least two fastening receiving holes at a first end and an elongated extension member at a second end, and a supporting bracket member configured as a channel for mounting on the glass door, the supporting bracket member defining at least two fastening receiving holes. The supporting bracket member is configured with at least one protruding member on a base of the channel such that the elongated extension member is configured to receive the at least one protruding member in an opening therein when in an assembled configuration. The elongated extension member has a screw receiving opening that is used to secure a bottom of the pivot hinge assembly to a shower base/threshold of the shower enclosure.

### TECHNICAL FIELD

The present invention relates to the field of bathroom hardware, and more particularly, to a pivot hinge assembly for supporting a glass door, for example, a glass door of a shower enclosure.

### BACKGROUND

For many years, the most commonly used enclosure for a tub/shower bathing facility has included a pair of sliding glass doors framed in metal. In a typical installation, an outer metal frame circumscribes the entry to the bath and is attached at the sides to the walls of the facility. The installation also includes a header spanning the entrance and a guide rail attached to the tub or shower base. The shower doors are hung at the top from the header and guided at the bottom by the rail so that they can slide back and forth in the entryway to allow entry and egress and to create a splash barrier.

There are several disadvantages with the described installation, both functional and aesthetic. First, the support structure is always present in the entryway to the bathing area, thus always at least partially blocking the entrance and restricting free access to the bathing area, a special problem when bathing a small child or when cleaning the facility. The header also adds an undesired obstruction in the entryway which must be avoided when entering or leaving the area. Moreover, the metal of the frame and all the glass-to-metal interfaces require special cleaning and maintenance. Apart from these functional constraints, the metal required for the framing, header and rail detracts from a clean and open appearance of the facility.

Various systems eliminating the shower door header have been utilized, including enclosure systems with the shower door hingedly or slidably connected to a glass panel, which is in turn mounted to an adjacent wall. Conventional enclosure systems are disadvantageous in that they use more hardware material than is desired and are hence heavier in appearance. In addition, conventional enclosure systems include many individual parts to assemble and install. Further, conventional enclosure systems are unable to be mounted independently from the stationary glass panel and wall profiles and hence are still connected to the wall.

It would thus be desirable to have a pivot hinge assembly for supporting a glass door, which is in turn supported by a glass panel or the like, among other desirable features as described herein, while avoiding the disadvantages of the known conventional enclosure systems.

### SUMMARY

In a first aspect, there is provided herein a pivot hinge assembly for supporting a glass door of a shower enclosure. The pivot hinge assembly includes: an exterior plate having a body configured for mounting on a glass panel such that the exterior plate defines at least two fastening receiving holes, a pivot mounting member having a body configured for mounting on an opposite side of the glass panel such that the pivot mounting member defines at least two fastening receiving holes at a first end and an elongated extension member at a second end, and a supporting bracket member configured as a channel for mounting on the glass door such that the supporting bracket member defines at least two fastening receiving holes. The supporting bracket member is configured with at least one protruding member on a base of the channel such that the elongated extension member is configured to receive the at least one protruding member in an opening therein when in an assembled configuration.

In certain embodiments, a first gasket body is disposed on an inner side of the exterior plate and a second gasket body is disposed on an inner side of the pivot mounting member such that the first gasket body and second gasket body are in direct contact with the glass panel when in the assembled configuration.

In certain embodiments, the pivot mounting member is secured to the exterior plate via at least two bolts such that the glass panel is stabilized therebetween.

In certain embodiments, an outer edge of the pivot mounting member and an outer edge of the exterior plate are adjoined via at least one pivot bumper with the glass panel stabilized therebetween.

In certain embodiments, a third gasket body is disposed on an inner side of the supporting bracket member at an opposite end of the at least two fastening receiving holes such that an outer side of the opposite end is in direct contact with the pivot mounting member when in the assembled configuration.

In certain embodiments, the glass door is positioned inside the channel of the supporting bracket member and secured by at least two screws such that the outer side of the opposite end is in direct contact with the pivot mounting member when in the assembled configuration.

In certain embodiments, a washer is disposed on the at least one protruding member such that the elongated extension member of the pivot mounting member is configured to receive the at least one protruding member in the opening therein when in the assembled configuration.

In certain embodiments, the glass panel is configured with at least two mounting holes therein.

In certain embodiments, the elongated extension member of the pivot mounting member is curved at one end.

In certain embodiments, the elongated extension member has a screw receiving opening that is used to secure a bottom of the pivot hinge assembly to a shower base/threshold of the shower enclosure.

In certain embodiments, the pivot hinge assembly is configured to be removed and replaced independently from a wall profile and the glass panel.

In a second aspect, there is provided herein a shower enclosure including a first pivot hinge assembly and a second pivot hinge assembly according to the exemplary embodiment described herein such that the first pivot hinge assembly is installed at a top edge of the glass panel for supporting the glass door and the second pivot hinge assembly is installed at a bottom edge of the glass panel for supporting the glass door when in the assembled configuration.

Various advantages of this disclosure will become apparent to those skilled in the art from the following detailed description, when read in light of the accompanying drawings.

### BRIEF DESCRIPTION OF THE DRAWINGS

FIG. 1 is a perspective view of an exemplary shower enclosure incorporating a pivot hinge assembly in accordance with an embodiment of the present disclosure.

FIG. 2 is an enlarged perspective view of a pivot hinge assembly in accordance with an embodiment of the present disclosure.

FIG. 3 is an exploded perspective view of the pivot hinge assembly of FIG. 2.

FIG. 4 is a top plan view of the pivot hinge assembly of FIG. 2.

FIG. 5 is a side elevational view of the pivot hinge assembly of FIG. 2.

FIG. 6 is a perspective view of the supporting bracket member of the pivot hinge assembly of FIG. 2.

FIG. 7 is a perspective view of the pivot mounting member of the pivot hinge assembly of FIG. 2.

FIG. 8 is a perspective view of the exterior plate of the pivot hinge assembly of FIG. 2.

FIG. 9 is an up close perspective view of the pivot hinge assembly of FIG. 1 installed on a top edge and a bottom edge of the glass panel, shown without the glass shower door, as viewed from inside of the shower in accordance with the present disclosure.

### DETAILED DESCRIPTION

This disclosure is not limited to the particular apparatus, systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All sizes recited in this document are by way of example only, and the present disclosure is not limited to the pivot hinge assembly having the specific sizes or dimensions recited herein. As used herein, the term “comprising” means “including, but not limited to.”

In consideration of the figures, it is to be understood for purposes of clarity certain details of construction and/or operation are not provided in view of such details being conventional and well within the skill of the art upon disclosure of the document described herein. In the figures, like numerals indicate like elements throughout.

The present disclosure pertains to a pivot hinge assembly for supporting a glass door, which is in turn supported by a glass panel or the like. The pivot hinge assembly increases the appearance of framelessness of the shower enclosure, reduces the total amount of hardware necessary, requires less drilling into a support wall, and reduces the amount of steps necessary in the installation process and hence requires less labor. The pivot hinge assembly allows the use of small wall profiles in which the pivot hinge assembly can be removed and replaced independently of the wall profile and the glass support panel.

In addition to the advantages described above, the pivot hinge assembly of the present disclosure is supported by the glass panel, which is sized and cut to support the entire weight of the hingedly connected glass door. The connection of the pivot hinge assembly to the glass panel removes the need for hardware extending to the wall. The mounting holes in the glass and the pivot hinge assembly reduce the stress on the glass support panel while providing sufficient support for the glass door panel. The pivot hinge assembly is designed to support the glass door without introducing excessive stress on the glass support panel, among other desirable features as described herein.

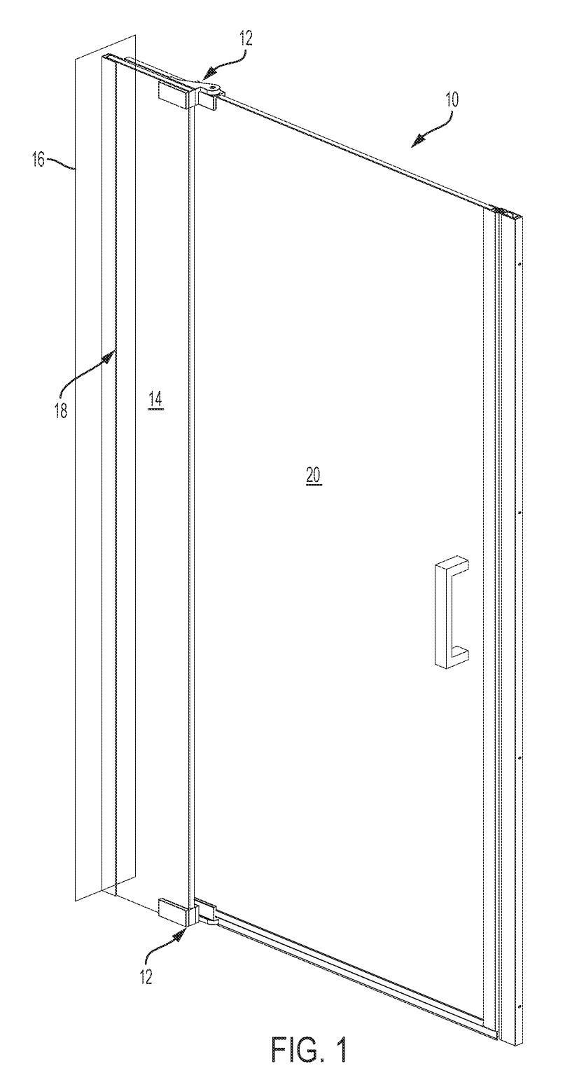

Referring now to FIG. 1 is a perspective view of an exemplary shower enclosure 10 incorporating a pivot hinge assembly 12 in accordance with an embodiment of the present disclosure. The shower enclosure 10 includes a glass panel 14 secured to a wall 16 via a longitudinal u-channel 18. A shower door 20 is hingedly connected to the glass panel 14 by a pair of hinges each in the form of pivot hinge assembly 12. Such a configuration maintains a clean aesthetic appearance for the shower enclosure 10. It should be understood that the pivot hinge assembly 12 is not limited to the shower enclosure 10 illustrated in FIG. 1. The illustrated shower enclosure in FIG. 1 is for illustration only as the pivot hinge assembly 12 may be utilized to support a glass panel in various shower enclosure configurations.

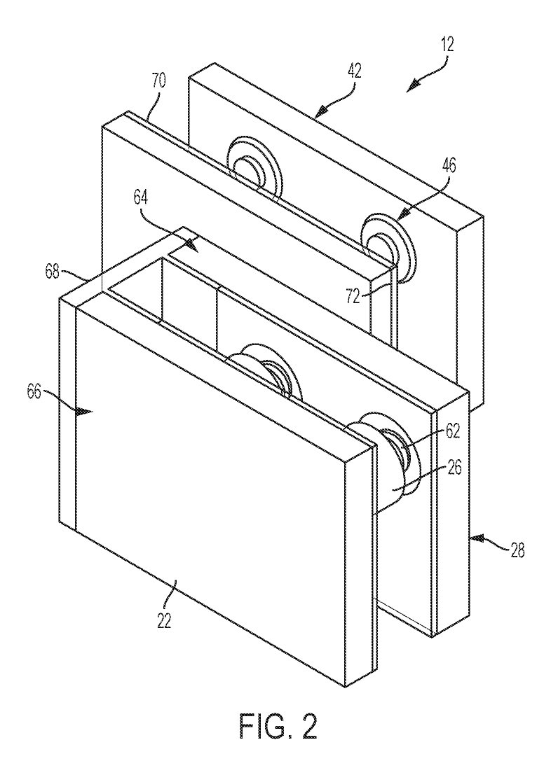

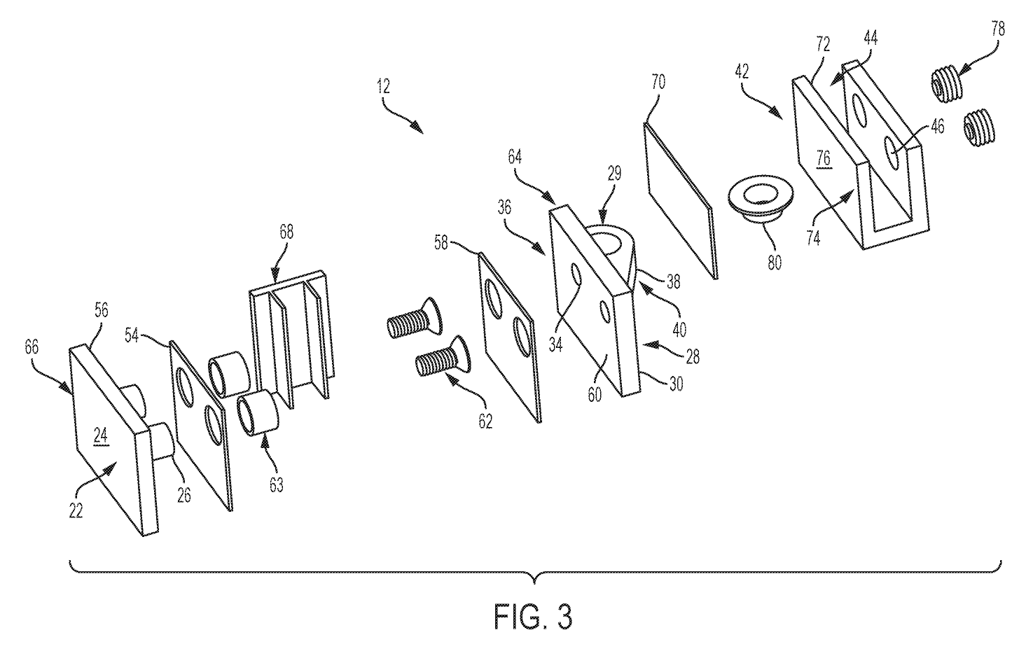

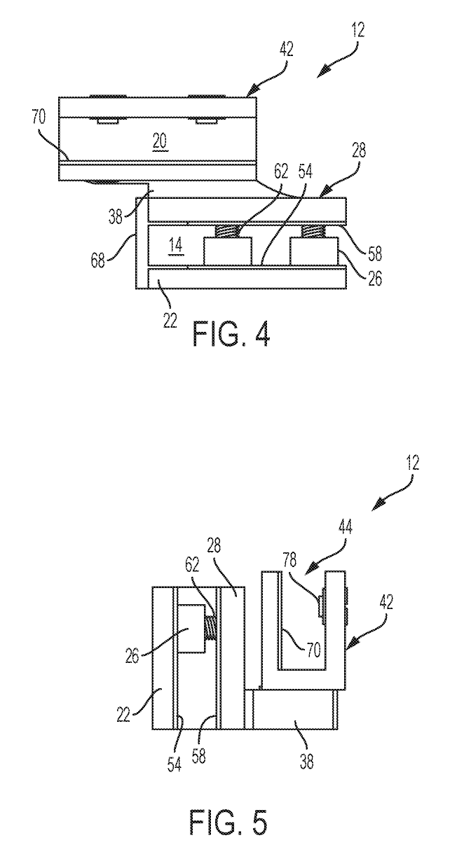

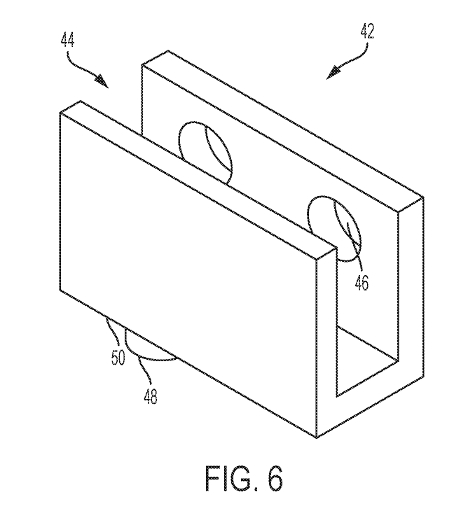

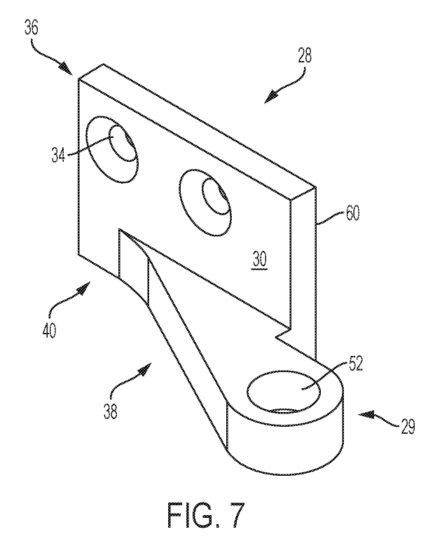

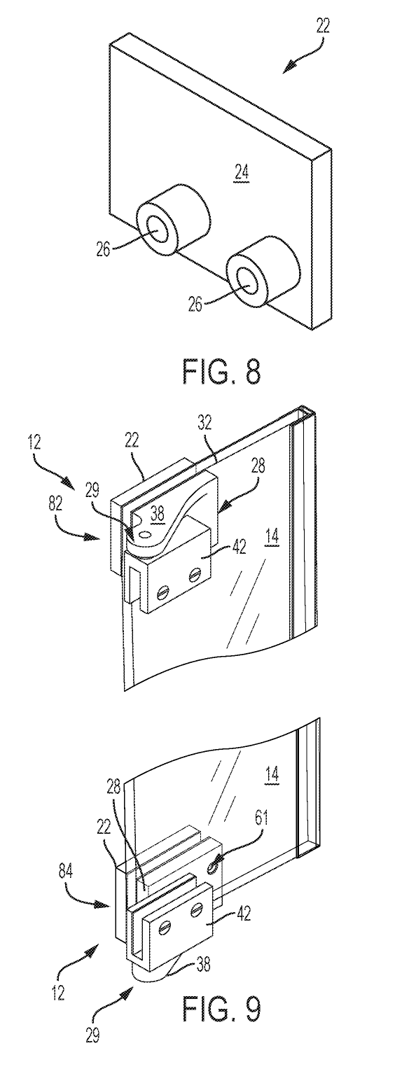

Referring to FIGS. 2-9, the pivot hinge assembly 12 will be described in more detail. The pivot hinge assembly 12 generally includes an exterior plate 22, a pivot mounting member 28, and a supporting bracket member 42. The exterior plate 22 has a body 24 configured for mounting on the glass panel 14. The exterior plate 22 defines at least two fastening receiving holes 26. The pivot mounting member 28 has a body 30 configured for mounting on an opposite side 32 of the glass panel 14. The pivot mounting member 28 defines at least two fastening receiving holes 34 at a first end 36 and an elongated extension member 38 at a second end 40. The supporting bracket member 42 is configured as a channel 44 for mounting on the glass door 20. The supporting bracket member defines at least two fastening receiving holes 46. The supporting bracket member 42 is configured with at least one protruding member 48 on a base 50 of the channel 44 such that the elongated extension member 38 of the pivot mounting member 28 is configured to receive the at least one protruding member in an opening 52 therein when in an assembled configuration (see FIG. 9).

In the illustrated embodiment, the pivot hinge assembly 12 includes a first gasket body 54 disposed on an inner side 56 of the exterior plate 22 and a second gasket body 58 disposed on an inner side 60 of the pivot mounting member 28 such that the first gasket body and second gasket body are in direct contact with the glass panel 14 when in an assembled configuration.

In some embodiments, the glass panel 14 is configured with at least two mounting holes 61 therein. The pivot mounting member 28 is secured to the exterior plate 22 via at least two bolts 62 with sleeves 63 extended through the at least two fastening receiving holes 34 of the pivot mounting member, the at least two mounting holes 61 of the glass panel 14, and the at least two fastening receiving holes 26 of the exterior plate, such that the glass panel 14 is stabilized therebetween the pivot mounting member and the exterior plate. It should be understood that the pivot mounting member 28 can be secured to the exterior plate 22 via other suitable securing mechanisms. A single larger diameter screw could be used if the glass to bracket contact surface is adequate. This would require a larger hole cut in the glass.

In some embodiments, an outer edge 64 of the pivot mounting member 28 and an outer edge 66 of the exterior plate 22 are adjoined via at least one pivot bumper 68 with the glass panel 14 stabilized therebetween. It should be understood that the outer edges 64, 66 of the pivot mounting member 28 and the exterior plate 22, respectively, can be adjoined via other suitable connecting mechanisms.

In the illustrated embodiment, a third gasket body 70 is disposed on an inner side 72 of the supporting bracket member 42 at an opposite end 74 of the at least two fastening receiving holes 46 such that an outer side 76 of the opposite end 74 is in direct contact with the pivot mounting member 28 when in an assembled configuration.

During installation of the pivot hinge assembly 12, the glass door 20 is positioned inside the channel 44 of the supporting bracket member 42 and secured by at least two set screws with a soft tip 78 extended through the at least two fastening receiving holes 46 of the supporting bracket member such that the outer side 76 of the opposite end 74 is in direct contact with the pivot mounting member 28 when in an assembled configuration. It should be understood that the pivot hinge assembly 12 can be used with different sizes of glass panels and glass doors in accordance with the present disclosure.

In some embodiments, a washer 80 is disposed on the at least one protruding member 48 such that the elongated extension member 38 of the pivot mounting member 28 is configured to receive the at least one protruding member in the opening 52 therein when in an assembled configuration. The elongated extension member 38 has a screw receiving opening that is used to secure the bottom pivot hinge assembly to the shower base/threshold of the shower area.

In the illustrated embodiment, the elongated extension member 38 of the pivot mounting member 28 is curved at one end 29. It should be understood that the elongated extension member can be fabricated of any suitable shape and size.

In further embodiments, the pivot hinge assembly 12 is configured to be removed and replaced independently from a wall profile 16 and the glass panel 14.

It should be understood that the pivot hinge assembly can be fabricated of plastic and/or other suitable sturdy materials, such as stainless steel, metal alloys and the like. It is presently contemplated that the pivot hinge assembly 12 can be fabricated in different shapes as long as the desired shape does not affect the bracket/glass contact area and the support points of the glass panel and glass door. It is further presently contemplated that the pivot hinge assembly 12 can be fabricated in different sizes and is sized to scale the particular shower enclosure selected to be installed in the bathroom space.

In accordance with the present disclosure, there is disclosed a shower enclosure 10 including a first pivot hinge assembly 12 and a second pivot hinge assembly 12 according to the exemplary embodiment described above such that the first pivot hinge assembly is installed at a top edge 82 of the glass panel 14 for supporting the glass door 20 and the second pivot hinge assembly is installed at a bottom edge 84 of the glass panel for supporting the glass door when in the assembled configuration. FIG. 9 is an up close perspective view of the pivot hinge assembly 12 of FIG. 1 installed on a top edge 82 and a bottom edge 84 of the glass panel 14, shown without the glass shower door, as viewed from inside of the shower in accordance with the present disclosure.

These and other advantages of the present disclosure will be apparent to those skilled in the art. Accordingly, it will be recognized by those skilled in the art that changes or modifications may be made to the above-described embodiments without departing from the broad inventive concepts of the present disclosure. It should therefore be understood that the present disclosure is not limited to the particular embodiments described herein, but is intended to include all changes and modifications that are within the scope and spirit of the disclosure as encompassed by the following claims.

What is claimed is:

1. A pivot hinge assembly for supporting a glass door of a shower enclosure, the pivot hinge assembly comprising:
an exterior plate having a body configured for mounting on a glass panel, the exterior plate defining at least two fastening receiving holes;
a pivot mounting member having a body configured for mounting on an opposite side of the glass panel, the pivot mounting member defining at least two fastening receiving holes at a first end and an elongated extension member at a second end;
a supporting bracket member configured as a channel for mounting on the glass door, the supporting bracket member defining at least two fastening receiving holes;
wherein the supporting bracket member is configured with at least one protruding member on a base of the channel such that the elongated extension member is configured to receive the at least one protruding member in an opening therein when in an assembled configuration.

2. The pivot hinge assembly of claim 1, wherein a first gasket body is disposed on an inner side of the exterior plate and a second gasket body is disposed on an inner side of the pivot mounting member such that the first gasket body and second gasket body are in direct contact with the glass panel when in the assembled configuration.

3. The pivot hinge assembly of claim 1, wherein the pivot mounting member is secured to the exterior plate via at least two bolts such that the glass panel is stabilized therebetween.

4. The pivot hinge assembly of claim 3, wherein an outer edge of the pivot mounting member and an outer edge of the exterior plate are adjoined via at least one pivot bumper with the glass panel stabilized therebetween.

5. The pivot hinge assembly of claim 1, wherein a third gasket body is disposed on an inner side of the supporting bracket member at an opposite end of the at least two fastening receiving holes such that an outer side of the opposite end is in direct contact with the pivot mounting member when in the assembled configuration.

6. The pivot hinge assembly of claim 5, wherein the glass door is positioned inside the channel of the supporting bracket member and secured by at least two screws such that the outer side of the opposite end is in direct contact with the pivot mounting member when in the assembled configuration.

7. The pivot hinge assembly of claim 1, wherein a washer is disposed on the at least one protruding member such that the elongated extension member of the pivot mounting member is configured to receive the at least one protruding member in the opening therein when in the assembled configuration.

8. The pivot hinge assembly of claim 1, wherein the glass panel is configured with at least two mounting holes therein.

9. The pivot hinge assembly of claim 1, wherein the elongated extension member of the pivot mounting member is curved at one end.

10. The pivot hinge assembly of claim 1, wherein the elongated extension member has a screw receiving opening that is used to secure a bottom of the pivot hinge assembly to a shower base/threshold of the shower enclosure.

11. The pivot hinge assembly of claim 1, wherein the pivot hinge assembly is configured to be removed and replaced independently of a wall profile and the glass panel.

12. A shower enclosure comprising:
a first pivot hinge assembly and a second pivot hinge assembly according to claim 1 such that the first pivot hinge assembly is installed at a top edge of the glass panel for supporting the glass door and the second pivot hinge assembly is installed at a bottom edge of the glass panel for supporting the glass door when in an assembled configuration.
